(19) United States
(12) Patent Application Publication
(10) Pub. No.: US 2012/0309217 A1
(43) Pub. Date: Dec. 6, 2012

(54) SLOT MODULE AND ELECTRONIC DEVICE USING THE SAME

(76) Inventors: Hsu-Tsung HUNG, Taipei (TW); Hsuan-Chang HU, Taipei (TW)

(21) Appl. No.: 13/211,828

(22) Filed: Aug. 17, 2011

(30) Foreign Application Priority Data
Jun. 3, 2011 (TW) 100119642

(51) Int. Cl. H01R 13/627

(52) U.S. Cl. 439/350

(57) ABSTRACT

A slot module and an electronic device using the same are provided. The slot module is used for being inserted by an insertion element having a positioning hole. The slot module includes a main body and several extending arms. The main body includes an insertion space and at least one positioning column. The positioning column is disposed in the insertion space and used for being inserted into the positioning hole. The extending arms are extended from sides of the main body and clamped sides of the insertion element.

This application claims the benefit of Taiwan application Serial No. 100119642, filed Jun. 3, 2011, the subject matter of which is incorporated herein by reference.

### BACKGROUND OF THE INVENTION

1. Field of the Invention

The invention relates in general to a slot module and an electronic device using the same, and more particularly to a slot module which assures the electrical connection with an insertion element after the insertion element is assembled thereon and an electronic device using the same.

2. Description of the Related Art

A conventional slot module only has two elastic lockers opposite to each other for locking an insertion element. However, such lockers may look engaged with the insertion element but the insertion element is not electrically connected to the slot module in reality. Therefore, such situation is referred as “false assembly”. When the insertion element is assembled on the slot module, the occurrence of slight inclination of the insertion element or small angle of deviation in assembly still allows the lockers to be engaged with the insertion element. However, the tiny deviation in the location of the insertion element is large enough to make the electrical connection become failed.

Meanwhile, the user may think the assembly of the insertion element is successful, but the electronic device still cannot be started up. When the user at last finds out it is a problem of false assembly that makes the electronic device unable to be started up, a large amount of time has already been wasted. To the worst, to start up a falsely assembled electronic device may cause damage to the electronic elements such as the insertion element. Thus, how to provide a slot module that can avoid false assembly has become an imminent task for the industries.

### SUMMARY OF THE INVENTION

The invention is directed to a slot module and an electronic device using the same. Through the structural design, the likelihood of maintaining the electrical connection between an insertion element and the slot module after the insertion element is assembled on the slot module is largely increased.

According to a first aspect of the present invention, a slot module is provided. The slot module is used for being inserted by an insertion element having a positioning hole. The slot module includes a main body and several extending arms. The main body includes an insertion space and at least one positioning column. The positioning column is disposed in the insertion space and used for being inserted into the positioning hole. The extending arms are extended from sides of the main body and clamped sides of the insertion element.

According to a second aspect of the present invention, an electronic device is provided. The electronic device includes a mechanism, an insertion element and a slot module. The insertion element is disposed in the mechanism, and has a positioning hole. The slot module is used for being inserted by the insertion element and is disposed in the mechanism. The slot module includes a main body and several extending arms. The main body includes an insertion space and at least one positioning column. The positioning column is disposed in the insertion space and used for being inserted into the positioning hole. The extending arms are extended from sides of the main body and clamped sides of the insertion element.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of an electronic device according to an embodiment of the invention;

FIG. 2A shows a schematic diagram of the insertion element and the slot module in FIG. 1 not yet engaged with each other;

FIG. 2B shows a schematic diagram of the insertion element and the slot module in FIG. 1 engaged with each other;

FIG. 3A shows a cross-sectional view taken along line A-A′ in FIG. 2A; and

FIG. 3B shows a cross-sectional view taken along line A-A′ in FIG. 2A viewed from another view angle.

### DETAILED DESCRIPTION OF THE INVENTION

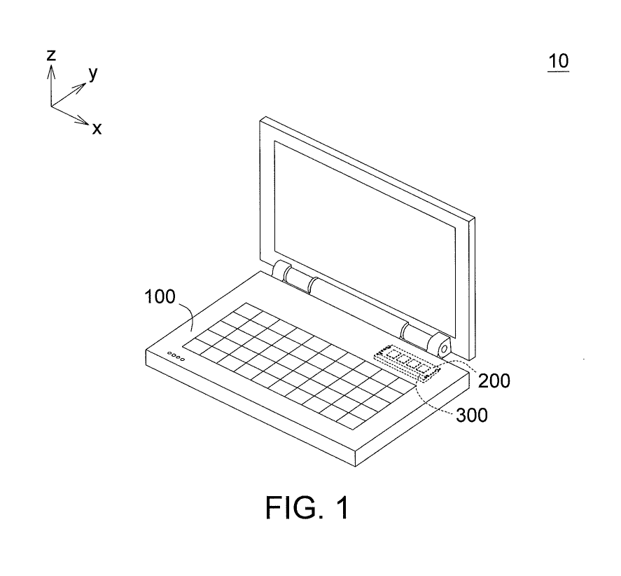

Referring to FIG. 1, a schematic diagram of an electronic device according to an embodiment of the invention is shown. The electronic device 10 includes a mechanism 100, an insertion element 200 and a slot module 300. The electronic device 10 can be realized by a notebook or a tablet personal computer, for example. The insertion element 200 can be realized by a small outline dual inline memory module (SODIMM), for example. The insertion element 200 and the slot module 300 are disposed in the mechanism 100. The insertion element 200 can be assembled on the slot module 300, so that the insertion element 200 is electrically connected to the slot module 300.

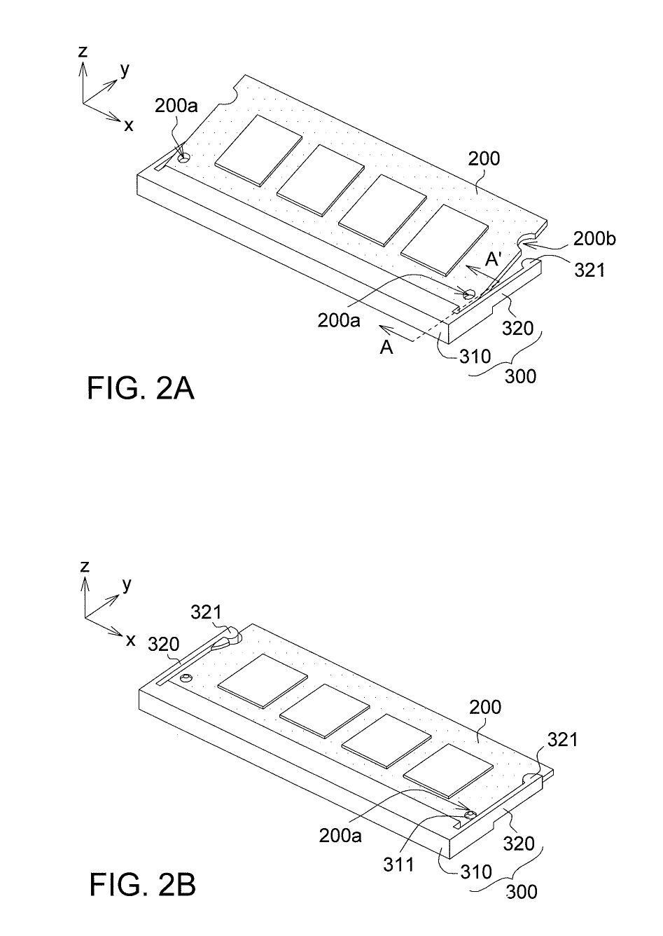

Referring to FIG. 2A and FIG. 2B, a schematic diagram of the insertion element and the slot module in FIG. 1 not yet engaged with each other is shown in FIG. 2A, and a schematic diagram of the insertion element and the slot module in FIG. 1 engaged with each other is shown in FIG. 2B. In the present embodiment of the invention, the slot module 300 includes a main body 310 and several extending arms 320. The extending arms 320 are extended towards a direction from sides of the main body 310 and clamped sides of the insertion element 200.

In the present embodiment of the invention, the number of the extending arms 320 can be two, and the two extending arms 320 are extended towards the +y-axis direction from two opposite sides of the main body 310 on the x-axis, respectively. Each of the two extending arms 320 respectively has a protruded structure 321, and the two protruded structures 321 are extended towards each other. In addition, each of two short sides of the insertion element 200 has a notch 200b, and the locations of the two notches 200b respectively correspond to the locations of the two protruded structures 321. Since the extending arms 320 are made from an elastic material, when the insertion element 200 is pressed to be inserted into the slot module 300, the insertion element 200 will prop the extending arms 320 open and make the extending arms 320 slightly deformed outwards. After the insertion element 200 is inserted into the slot module 300 as indicated in FIG. 2B, the extending arms 320 will return to their original locations. Meanwhile, the protruded structures 321 interfere with the structure of the insertion element 200 around the notches 200b corresponding to the protruded structures 321. Therefore, the insertion element 200 can not move towards the +z-axis direction, and the insertion element 200 will not come off the main body 300.

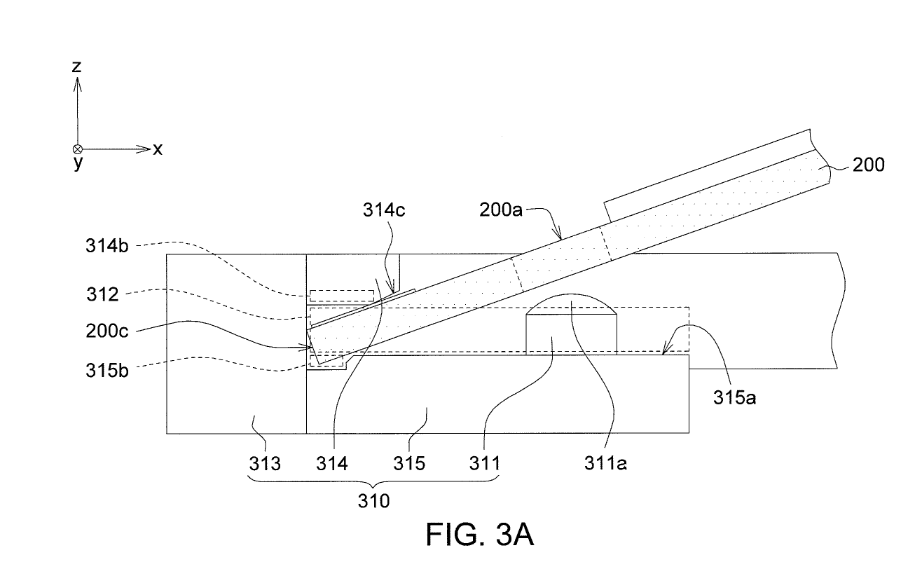

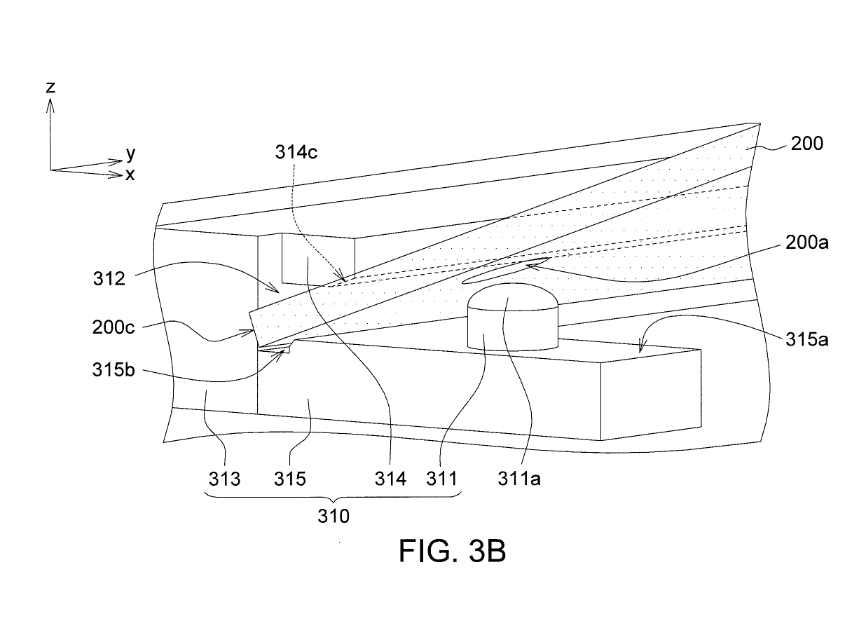

The following elaboration is accompanied by FIG. 3A being a primary diagram and FIG. 3B being an auxiliary diagram. FIG. 3A shows a cross-sectional view taken along line A-A′ in FIG. 2A. FIG. 3B shows a cross-sectional view taken along line A-A′ in FIG. 2A viewed from another view angle. The main body 310 includes a side body 313, an upper body 314 and a lower body 315. The side body 313, the upper body 314 and lower body 315 can be integrally formed in one piece. The upper body 314 and the lower body 315 are extended from a side of the side body 313. For example, the upper body 314 and the lower body 315 are both extended from a y-z plane of the side body 313 near the +x-axis. An insertion space 312 is formed by the side body 313, the upper body 314 and the lower body 315 for accommodating a part of the insertion element 200.

In the present embodiment of the invention, the main body 310 further includes at least one positioning column 311 disposed in the insertion space 312. The insertion element 200 has at least one positioning hole 200a. The positioning column 311 is inserted into the positioning hole 200a. After the insertion element 200 is assembled on the slot structure 300, the positioning column 311 and the insertion element 200 interfere with each other, so that the insertion element 200 is positioned more stably and will not be displaced easily when receiving an external force. The positioning hole 200a is used as a positioning hole for cutting a printed circuit board during the manufacturing of the insertion element 200. However, the positioning hole 200a can also be designed to be at a particular location on the insertion element 200.

In the present embodiment of the invention, the length for which the lower body 315 is extended from the side body 313 is larger than the length for which the upper body 314 is extended from the side body 313. The positioning column 311 can be disposed on a surface 315a of the lower body 315, and the surface 315a faces the upper body 314. In the present embodiment of the invention, the number of the positioning columns 311 can be two, for example, and the positions of the two positioning columns 311 respectively correspond to those of the two positioning holes 200a of the insertion element 200. Thus, after the insertion element 200 is slantly inserted into the insertion space 312, the locations of the positioning holes 200a must correspond to those of the positioning columns 311, so that the insertion element 200 can be pressed downward for enabling the positioning columns 311 to be inserted into the positioning holes 200a. Further, the insertion element 200 is moved downward onto the surface 315a of the lower body 315, and the part of the insertion element 200 is located in the insertion space 312. Thus, the assembly is completed.

If the locations of the positioning holes 200a do not correspond to those of the positioning columns 311 (for example, the insertion element 200 is not aligned with the slot module 300, or the insertion element 200 is inserted into the insertion space 312 too deep or too shallow), then the insertion element 200 cannot be moved downward further. Meanwhile, the contact between the insertion element 200 and the positioning column 311 forms a pivotal point, and the upper body 314 generates a torque with respect to an end 200c of the insertion element 200 for resisting the downward force applied on the insertion element 200 by the user. Through the disposition of the positioning column 311, the insertion element 200 is assembled to the slot structure 300 only when the positioning hole 200a corresponds to the positioning column 311. Thus, when the insertion element 200 is assembled to the slot structure 300, the insertion element 200 is electrically connected to the slot structure 300 definitely, and false assembly is avoided (false assembly refers to the situation that elements are assembled together in appearance but are not electrically connected in reality).

In the present embodiment of the invention, the lower body 315 has a buffer space 315b disposed at the part near the side body 313 and below the insertion space 312. When the insertion element 200 is slantly inserted into the insertion space 312, the part of the insertion element 200 near the end 200c will enter the buffer space 315b. The buffer space 315b allows the insertion element 200 to easily rotate therein, so that the positioning column 311 can be inserted into the positioning hole 200a. The upper body 314 has a pressing portion 314b disposed at the part near the side body 313 and located at the bottom portion of the upper body 314. When the insertion element 200 is assembled on the slot module 300, the pressing portion 314b leans against the top surface of the insertion element 200 near the end 200c to prevent the part of the insertion element 200 near the end 200c from moving upward so as to maintain assembly stability.

Please Refer to FIG. 3A. In the present embodiment of the invention, a conductive element (not illustrated) can be formed on the wall by which the insertion space 312 is formed. A conductive element can be, for example, a gold finger (not illustrated) and is disposed on the surface of the insertion element 200 near the end 200c. When the end 200c of the insertion element 200 is inserted into the insertion space 312 and the assembly is completed, the conductive element of the insertion element 200 can be electrically connected to the conductive element on the wall by which the insertion space 312 is formed, so that the insertion element 200 is electrically connected to the slot module 300.

In the present embodiment of the invention, a corner 314c of the upper body 314 is a bevel angle, and the corner 314c faces the lower body 315. When the insertion element 200 is inserted into the insertion space 312, the insertion element 200 can enter the insertion space 312 along the corner 314c which is the bevel angle, so that the assembler can have better handling in assembly. Thus, the insertion element 200 will not be damaged by the violent force applied by the assembler due to the difficulty in assembly.

In the present embodiment of the invention, the structure of a side of the positioning column 311 protruded outwardly is substantially an arc structure 311a, and the arc structure 311a can be realized by a round-corner structure, for example. When the insertion element 200 is inserted into the slot module 300, the arc structure 311a makes it easier for the positioning column 311 to enter the positioning hole 200a of the insertion element 200, so that assembly will not fail or turn difficult simply because of small assembly deviation. Thus, the assembler will have better handling and convenience in assembly.

The slot module provided in the present embodiment of the invention includes the positioning column whose location corresponds to that of the positioning hole of the insertion element. When the insertion element is assembled on the slot module, there is interference between the positioning column and the positioning hole of the insertion element in addition to the interference between the extending arms and the insertion element. Thus, the likelihood of maintaining the electrical connection between the insertion element and the slot module after the insertion element is assembled on the slot module can be largely increased and the situation that the insertion element comes off the main body during delivery can be avoided. The slot module provided in the present embodiment of the invention avoids the occurrence of false assembly which may further cause the electronic elements to be burnt down when a falsely assembled electronic device is started up or may end up with startup failure, and reduces the potential loss of time and money for the industries and consumers as well.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A slot module used for being inserted by an insertion element, wherein the insertion element has a positioning hole, and the slot module comprises:
a main body comprising an insertion space and at least one positioning column, wherein the positioning column is disposed in the insertion space and used for being inserted into the positioning hole; and
a plurality of extending arms extended from sides of the main body and clamped sides of the insertion element.

2. The slot module according to claim 1, wherein the main body comprises a side body, an upper body and a lower body, the upper body and the lower body are extended from a side of the side body, the insertion space is formed by the side body, the upper body and the lower body, and the positioning column is disposed on the lower body.

3. The slot module according to claim 2, wherein a corner of the upper body is a bevel angle, and the corner faces the lower body.

4. The slot module according to claim 2, wherein the upper body has a pressing portion disposed at the part near the side body, the lower body has a buffer space disposed at the part near the side body and used as a rotation working space when the insertion element is slantly inserted into the insertion space, and the pressing portion presses the insertion element when the positioning column is inserted into the positioning hole.

5. The slot module according to claim 1, wherein the structure of a side of the positioning column protruded outwardly is substantially an arc structure.

6. An electronic device, comprising:
a mechanism;
an insertion element disposed in the mechanism and having a positioning hole; and
a slot module used for being inserted by the insertion element and disposed in the mechanism, wherein the slot module comprises:
a main body comprising an insertion space and at least one positioning column, wherein the positioning column is disposed in the insertion space and used for being inserted into the positioning hole; and
a plurality of extending arms extended from sides of the main body and clamped sides of the insertion element.

7. The electronic device according to claim 6, wherein the main body comprises a side body, an upper body and a lower body, the upper body and the lower body are extended from a side of the side body, the insertion space is formed by the side body, the upper body and the lower body, and the positioning column is disposed on the lower body.

8. The electronic device according to claim 7, wherein a corner of the upper body is a bevel angle, and the corner faces the lower body.

9. The electronic device according to claim 7, wherein the upper body has a pressing portion disposed at the part near the side body, the lower body has a buffer space disposed at the part near the side body and used as a rotation working space when the insertion element is slantly inserted into the insertion space, and the pressing portion presses the insertion element when the positioning column is inserted into the positioning hole.

10. The electronic device according to claim 6, wherein the structure of a side of the positioning column protruded outwardly is substantially an arc structure.
